(19) United States
(12) Patent Application Publication
(10) Pub. No.: US 2014/0156279 A1
(43) Pub. Date: Jun. 5, 2014

(54) CONTENT SEARCHING APPARATUS, CONTENT SEARCH METHOD, AND CONTROL PROGRAM PRODUCT

(71) Applicants: Mitsuhiko Sakai, Hakui-shi (JP); Kabushiki Kaisha Toshiba, Tokyo (JP)

(72) Inventors: Masayuki OKAMOTO, Kanagawa (JP); Hiroko FUJII, Tokyo (JP); Daisuke SANO, Tokyo (JP); Masaru SAKAI, Ishikawa (JP)

(73) Assignee: Kabushiki Kaisha Toshiba, Tokyo (JP)

(21) Appl. No.: 14/024,154

(22) Filed: Sep. 11, 2013

(30) Foreign Application Priority Data
Nov. 30, 2012 (JP) 2012-263583

(51) Int. Cl. G10L 15/18

(52) U.S. Cl. CPC G10L 15/18
USPC 704/257

(57) ABSTRACT

According to one embodiment, a content searching apparatus includes: a search condition generator configured to perform voice recognition in parallel with an input of a natural language voice giving an instruction for a search for a piece of content, and to generate search conditions sequentially; a searching module configured to perform a content search while updating the search condition used in the search as the search condition is generated; and a search result display configured to update the search condition used in the content search and a result of the content search based on the search condition to be displayed as the search condition is generated.

### CROSS-REFERENCE TO RELATED APPLICATIONS

This application is based upon and claims the benefit of priority from Japanese Patent Application No. 2012-263583, filed Nov. 30, 2012, the entire contents of which are incorporated herein by reference.

### FIELD

Embodiments described herein relate generally to a content searching apparatus, a content search method, and a control program product.

### BACKGROUND

Conventionally known is an information searching apparatus that recognizes a voice, extracts one or more keywords from the voice thus entered, and searches an information database using all of the keywords thus extracted.

Such a conventional information searching apparatus needs to search an information database after waiting for a speech to complete.

As a result, all keywords are used in performing a search, and it has been difficult to enter a voice for allowing a more exact search to be performed. Furthermore, because the voice once entered cannot be modified, everything needs to be re-entered if any phrase is entered incorrectly, which is not very user-friendly.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic for explaining a general configuration of a content search system according to an embodiment;

FIG. 2 is an exemplary block diagram of a general configuration of a tablet in the embodiment;

FIG. 3 is an exemplary functional block diagram of the tablet in the embodiment;

FIG. 4 is an exemplary flowchart of a process in the embodiment;

FIGS. 5A to 5C are exemplary schematics for explaining a first exemplary approach for displaying search results on a touch panel display in the embodiment;

FIGS. 6A to 6C are exemplary schematics for explaining a second exemplary approach for displaying search results on the touch panel display in the embodiment;

FIGS. 7A to 7C are exemplary schematics for explaining a third exemplary approach for displaying search results on the touch panel display in the embodiment;

FIGS. 8A to 8D are exemplary schematics for explaining a fourth exemplary approach for displaying search results on the touch panel display in the embodiment;

FIGS. 9A and 9B are exemplary schematics for explaining a fifth exemplary approach for displaying search results on the touch panel display in the embodiment;

FIG. 10 is an exemplary schematic for explaining an example transiting operation for transiting to a replaying operation in the middle of a search in the embodiment;

FIGS. 11A and 11B are exemplary schematics for explaining a first approach for updating displayed content in the embodiment;

FIGS. 12A and 12B are schematics for explaining a second approach for updating displayed content in the embodiment;

FIGS. 13A to 13C are exemplary schematics for explaining a third approach for updating displayed content in the embodiment;

FIGS. 14A and 14B are exemplary schematics for explaining a fourth approach for updating displayed content in the embodiment;

FIGS. 15A and 15B are exemplary schematics for explaining a fifth approach for updating displayed content in the embodiment;

FIGS. 16A and 16B are exemplary schematics for explaining a sixth approach for updating displayed content in the embodiment; and

FIGS. 17A and 17B are exemplary schematics for explaining a seventh approach for updating displayed content in the embodiment.

### DETAILED DESCRIPTION

In general, according to one embodiment, a content searching apparatus comprises: a search condition generator configured to perform voice recognition in parallel with an input of a natural language voice giving an instruction for a search for a piece of content, and to generate search conditions sequentially; a searching module configured to perform a content search while updating the search condition used in the search as the search condition is generated; and a search result display configured to update the search condition used in the content search and a result of the content search based on the search condition to be displayed as the search condition is generated.

An embodiment will now be explained with reference to some drawings.

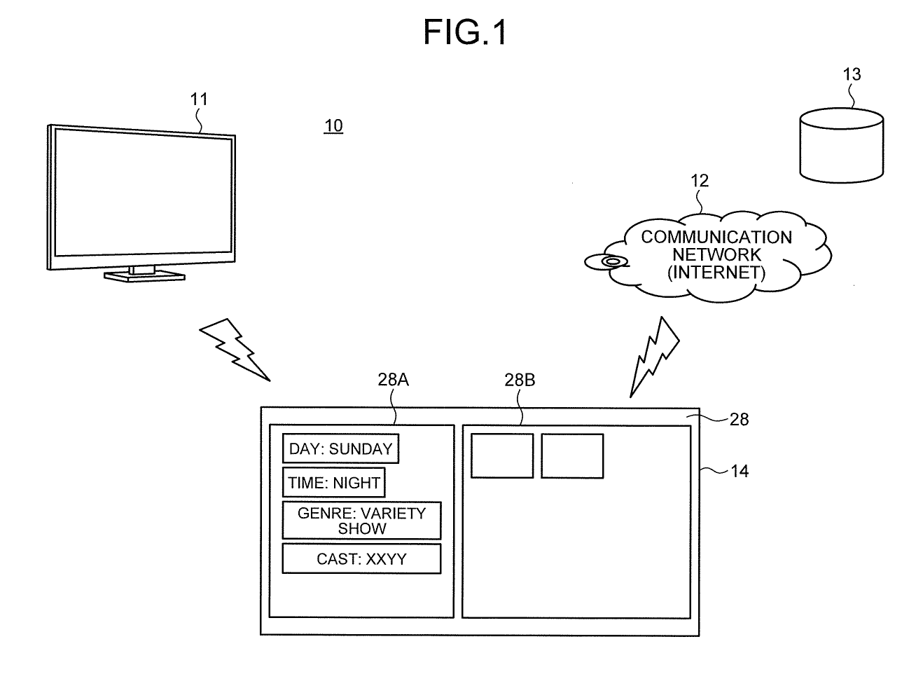

FIG. 1 is a schematic for explaining a general configuration of a content search system according to an embodiment.

This content search system. 10 comprises a television 11 and a tablet 14. The television 11 functions as a content replaying apparatus that replays various types of content. The tablet 14 functions as a content searching apparatus as well as a remote controller. The content searching apparatus searches for a piece of content by recognizing a voice such as an input voice, extracting a keyword from the voice, and accessing a content database (DB) 13 such as an electronic program guide (EPG) over a communication network 12 such as the Internet, using the keyword thus extracted. The remote controller controls the television 11 to cause the television 11 to replay content based on a result of the content search. Explained in the embodiment is a configuration in which the tablet 14 performs all of the functions of the content searching apparatus, but other various configurations are also possible. For example, the television 11 may be provided with the function of voice recognition, the function for storing the data in a database, and the function for searching a piece of content. Alternatively, a server connected over the communication network 12 may be provided with the functions of voice recognition, the function for storing the data in a database, and the function for searching a piece of content.

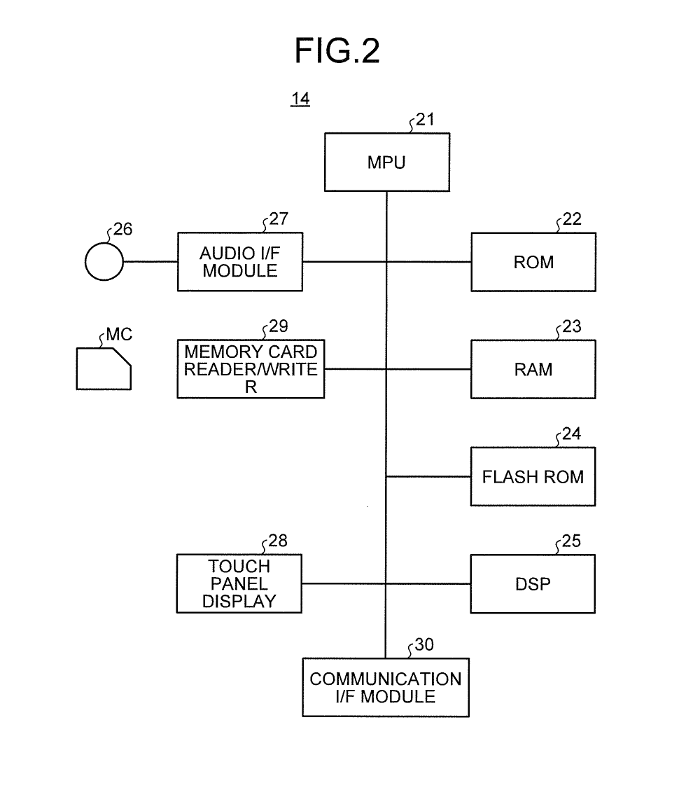

FIG. 2 is a block diagram of a general configuration of the tablet.

The tablet 14 comprises a micro-processing unit (MPU) 21, a read-only memory (ROM) 22, a random access memory (RAM) 23, a flash ROM 24, a digital signal processor (DSP) 25, a microphone 26, an audio interface (I/F) module 27, a touch panel display 28, a memory card reader/writer 29, and a communication interface module 30. The MPU 21 controls the entire tablet 14. The ROM 22 is a nonvolatile memory storing various types of data such as a control program. The RAM 23 stores therein various types of data temporarily. The flash ROM 24 is in a nonvolatile memory storing various types of data in an updatable manner. The DSP 25 performs digital signal processing such as voice signal processing. The microphone 26 converts an input voice into an input voice signal. The audio I/F module 27 performs an analog-to-digital conversion to the input voice signal received from the microphone 26, and outputs input voice data. Integrated in the touch panel display 28 are a display such as a liquid crystal display for displaying various types of information and a touch panel for performing various input operations. A semiconductor memory card MC is inserted into the memory card reader/writer 29, and the memory card reader/writer 29 reads and writes various types of data. The communication interface module 30 performs communications wirelessly.

The communication interface module 30 has a function of remotely controlling the television 11 wirelessly using infrared or the like, as well as the communications over the communication network 12.

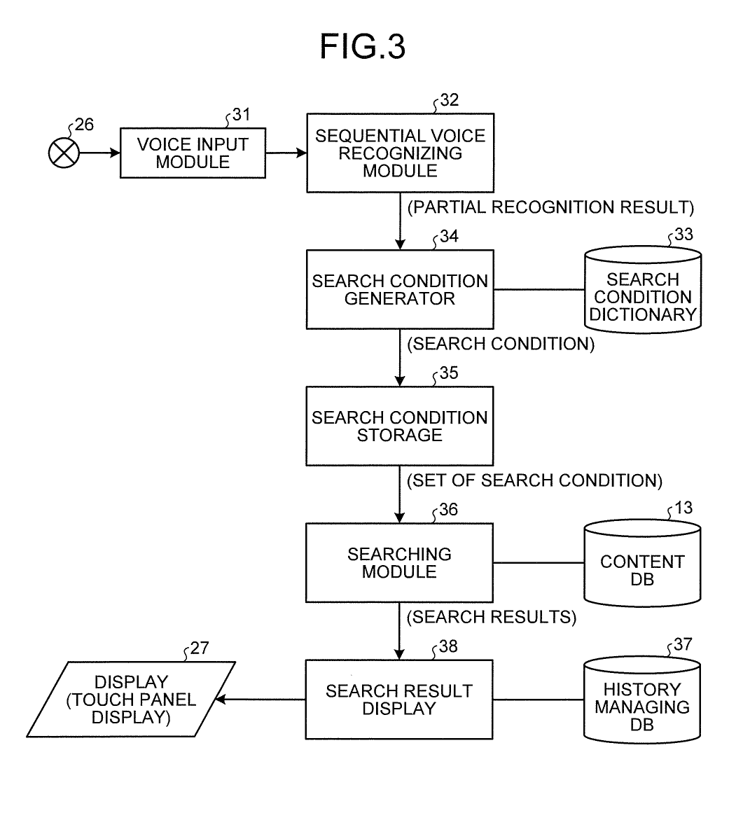

FIG. 3 is a functional block diagram of the tablet.

The tablet 14 comprises a voice input module 31, a sequential voice recognizing module 32, a search condition generator 34, a search condition storage 35, a searching module 36, and a search result display 38. The voice input module 31 applies filtering, waveform shaping, an analog-to-digital conversion, and the like to an input voice signal received via the microphone 26, whereby converting the input voice signal into digital voice data, and outputs the digital voice data to the sequential voice recognizing module 32. The sequential voice recognizing module 32 receives the digital voice data from the voice input module 31, applies a voice recognition process to the digital voice data sequentially, and outputs voice text data being the results of the voice recognition process to the search condition generator 34 sequentially. Upon receiving the voice text data from the sequential voice recognizing module 32, the search condition generator 34 extracts a search keyword, which is for searching a piece of content, from the voice text data by referring to a search condition dictionary 33, and generates a search condition using the search keyword thus extracted. The search condition dictionary 33 is stored in the ROM 22 or in the flash ROM 24 in advance. The search condition storage 35 then stores the search condition generated by the search condition generator 34 in the RAM 23. The searching module 36 reads a set of search conditions stored by the search condition storage 35 from the RAM 23, accesses the content DB 13 over the communication network 12, and performs a search for a piece of content. The search result display 38 displays the search result received from the searching module 36 on the touch panel display 28 functioning as a display in a given display format specified in advance, and stores a display history in a history managing DB 37 established on the flash ROM 24.

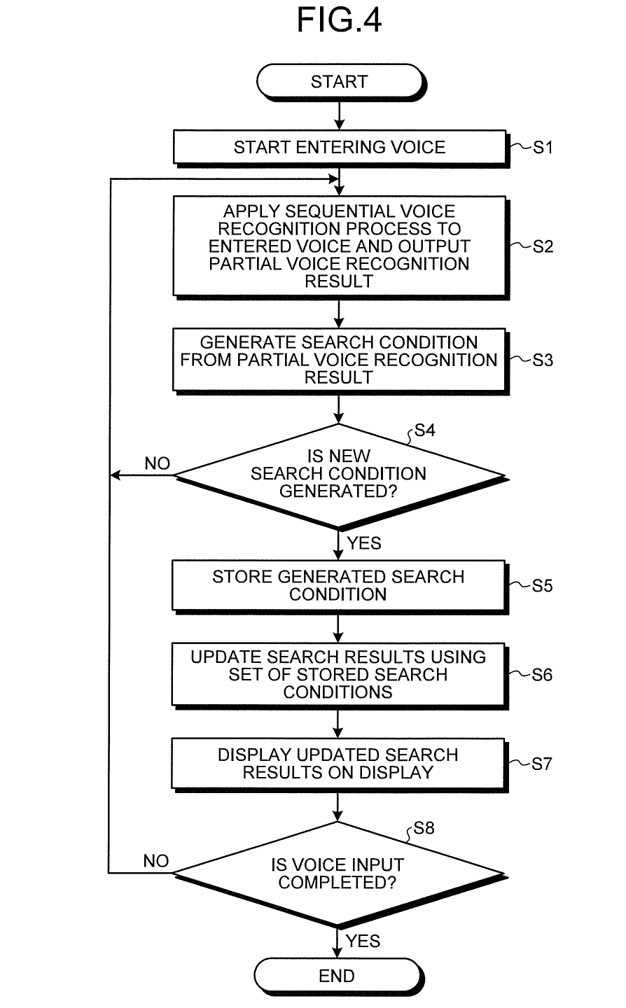

FIG. 4 is a flowchart of a process in the embodiment.

Operations performed by the tablet 14 will now be explained with reference to FIG. 4.

To begin with, the voice input module 31 receives a voice of a user of the tablet 14 as digital voice data via the microphone 26, and outputs the digital voice data to the DSP 25 functioning as the sequential voice recognizing module 32 (51).

The DSP 25 functioning as the sequential voice recognizing module 32 performs a voice recognition process to the voice thus entered, and outputs the details of the entered voice as text data, which is a voice recognition result (S2).

At this time, the DSP 25 functioning as the sequential voice recognizing module 32 outputs a partial voice recognition result, which is a voice recognition result corresponding to a part of the spoken voice, sequentially and sequentially, instead of outputting the voice recognition result after the entire spoken voice is entered.

The sequential voice recognition process will now be explained specifically.

Explained below is an example in which a voice spoken by a user is “the variety show on Sunday night, well, the one Mr. XXYY is on ( [symbol] [symbol] ◯◯ΔΔ [symbol] )”

The sequential voice recognizing module 32 performs the voice recognition process from the head of the entered voice sequentially, and outputs partial voice recognition results being “variety show ( [symbol] )”, “on Sunday night ( [symbol] )”, “well ( [symbol] )”, and “the one Mr. XXYY is on (◯◯ΔΔ [symbol] ”))”, sequentially, as the voice is entered. Such partial voice recognition results are output at the timing at which a highly reliable intermediate hypothesis is acquired or at which a short pause is detected in the entered voice during the voice recognition process.

The MPU 21 functioning as the search condition generator 34 refers to the search condition dictionary 33 stored in the ROM 22 or the flash ROM 24, analyses the input text data being the partial voice recognition results, and generates search conditions sequentially, as an analyzer and generator (S3).

In the embodiment, the MPU 21 generates a condition for searching a piece of program content, based on a keyword included in the entered voice, in a format “attribute: keyword” which is a combination of the keyword and an attribute to which the keyword belongs.

More specifically, “attribute” and “keyword” are predetermined items in which information about a piece of program content and a specific value are respectively specified. Examples of the “attribute” include “day”, “time”, “genre”, “title”, and “cast”.

An “attribute” has some corresponding “keyword”. Examples of the attribute “day” include “Sunday”, “Monday”, “new year's holiday”, and “new year's special program”, and examples of an attribute “time” includes “morning”, “daytime”, and “night”.

In the embodiment, combinations of an attribute and a keyword are acquired from the content DB 13 such as an EPG in which information of program content is described, and stored in the search condition dictionary 33.

The MPU 21 functioning as the search condition generator 34 refers to the search condition dictionary 33 based on input text data, “on Sunday night ( [symbol] )” which is a partial voice recognition result, and generates search conditions “day: Sunday ( [symbol] )” and “time: night ( [symbol] )”.

The MPU 21 also generates a search condition “genre: variety ( [symbol] )” for another piece of text data “variety show ( [symbol] )”, which is another partial voice recognition result.

There are some cases in which the MPU 21 is incapable of generating a search condition from a partial voice recognition result. For example, the MPU 21 does not generate any search condition for a partial voice recognition result “well”, because any keyword corresponding to an input of text data of a partial voice recognition result “well” is not described in the search condition dictionary 33.

In the embodiment, the MPU 21 performs this process under an assumption that an attribute and a keyword are paired, as explained above. Alternatively, only a keyword corresponding to a given attribute may be used as a part of a search condition, without any attribute assigned to the search condition.

The MPU 21 then determines if any new search condition is generated (S4).

In the determination at S4, if any new search condition is not generated (No at S4), the process is returned to S2, and the MPU 21 performs the next sequential voice recognition process (S2).

In the determination at S4, if a new search condition is generated (Yes at S4), in other words, if the MPU 21 functioning as the search condition generator 34 generates a new search condition, the MPU 21 stores the search condition thus generated in the RAM 23 functioning as the search condition storage 35 (S5).

For example, if search conditions “day: Sunday ( [symbol] )” and “time: night ( [symbol] )” are generated, the MPU 21 stores these search conditions in the RAM 23.

When the MPU 21 newly generates a search condition “genre: variety ( [symbol] [symbol] )”, the MPU 21 adds the search condition to the RAM 23.

Through the sequence of these operations, a set of search conditions generated up to the point are stored in the RAM 23 functioning as the search condition storage 35.

The MPU 21 functioning as the searching module 36 then refers to the content DB 13 via the communication interface module 30 and the communication network 12.

As a search condition is added to the RAM 23 functioning as the search condition storage 35, the MPU 21 functioning as the searching module 36 searches a piece of program content using a set of search conditions stored in the search condition storage 35, and updates the search results (S6).

In the embodiment, the content DB 13 is a database in which information about pieces of program content are described, e.g., typically an EPG. In the content DB 13, the association between an “attribute” and a “keyword” is described for each piece of program content.

The MPU 21 functioning as the searching module 36 then refers to “attributes” and “keywords” stored in the content DB 13 using a set of search conditions stored in the RAM 23 functioning as the search condition storage 35, and sets a set of program content having a matching set of search conditions to the RAM 23 as the search results. The MPU 21 functioning as the search result display 38 then displays the search results received from the searching module 36 on the screen of the touch panel display 28 (S7).

The MPU 21 then determines if the voice input is completed (S8).

In the determination at S8, if the voice input is not completed yet (No at S), the process is returned to S2, the same process is performed subsequently.

In the determination at S8, if the voice input is completed (Yes at S), the process is ended.

Examples of approaches for displaying the search results will now be explained.

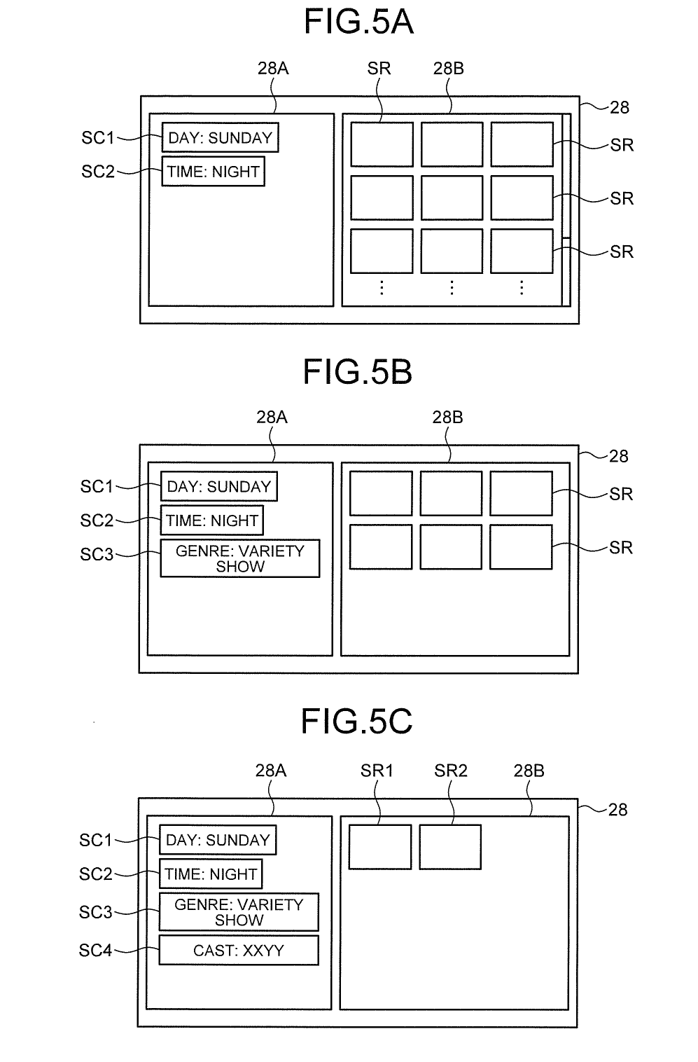

FIGS. 5A to 5C are exemplary schematics for explaining a first exemplary approach for displaying search results on a touch panel display in the embodiment.

As illustrated in FIGS. 5A to 5C, the MPU 21 functioning as the search result display 38 only displays the pieces of content matching a set of search conditions at a given point in time.

FIG. 5A illustrates how the search results are displayed at the point in time at which the search conditions “day: Sunday ( [symbol] )” and “time: night ( [symbol] )” are stored as a set of search conditions in the RAM 23.

As illustrated in FIG. 5A, the screen of the touch panel display 28 is divided into a search condition display area 28A and a search result display area 28B.

At this time, the search condition display area 28A displays a search condition SC1=“day: Sunday ( [symbol] )” and a search condition SC2=“time: night ( [symbol] )”, and it can be seen that a search is performed using these two search conditions SC1 and SC2.

The search result display area 28B displays at least nine search results SR, as results of the search performed using these two search conditions SC1 and SC2.

The tablet 14 may also be caused to function as a what is called a remote controller using the communication interface module 30 so that, when the user finds that a desired piece of program content is included in the search results SR displayed in the search result display area 28B and selects the search result SR by touching, the piece of program content corresponding to the search result SR is displayed on the television 11 (the same can be said in the explanations below).

FIG. 5B illustrates how the search results are displayed at a point in time at which a search condition “genre: variety ( [symbol] : [symbol] )” is stored in the RAM 23, in addition to the search conditions “day: Sunday ( [symbol] )” and “time: night ( [symbol] )”, as a set of search conditions.

As illustrated in FIG. 5B, the search condition SC1=“day: Sunday ( [symbol] )”, the search condition SC2=“time: night ( [symbol] )”, and a search condition SC3=“genre: variety ( [symbol] )” are displayed in the search condition display area 28A in the screen of the touch panel display 28, and it can be seen that a search is performed using these three search conditions SC1 to SC3.

In the search result display area 28B, six search results SR are displayed as results of a search using three search conditions SC1 to SC3.

FIG. 5C illustrates how the search results are displayed at a point in time at which a search condition “cast: XXYY ( [symbol] : ◯◯ΔΔ)” is stored in the RAM 23, in addition to the search conditions “day: Sunday ( [symbol] )”, “time: night ( [symbol] )”, and “genre: variety ( [symbol] )”, as a set of search conditions.

As illustrated in FIG. 5C, in the search condition display area 28A of the screen of the touch panel display 28, the search condition SC1=“day: Sunday ( [symbol] )”, the search condition SC2=“time: night ( [symbol] )”, the search condition SC3=“genre: variety ( [symbol] )”, and a search condition SC4=“cast: XXYY ( [symbol] : ◯◯ΔΔ)” are displayed, and it can be seen that a search is performed using these four search conditions SC1 to SC4.

In the search result display area 28B, two search results SR1 and SR2 are displayed as results of a search performed using these four search conditions SC1 to SC4.

As explained above, in the first exemplary approach for displaying the search results on the touch panel display, the search conditions are sequentially added so as to refine the search results, and only the search results thus refined are displayed. Therefore, a user can recognize the search results corresponding to what is spoken by the user quickly, and perform a search smoothly.

Furthermore, when an intended piece of program content is displayed as a search result while the user is still speaking (for example, at the point in time the screen illustrated in FIG. 5B is displayed), the user can make a tapping operation or the like for selecting the search result, and cause the television 11 to replay the content. In this manner, content can be searched simply and quickly.

During the time a piece of content is being searched, because pieces of program content other than the intended piece are displayed, a user can find similar content, and can experience the joy of searching, e.g., in discovering some content unexpectedly.

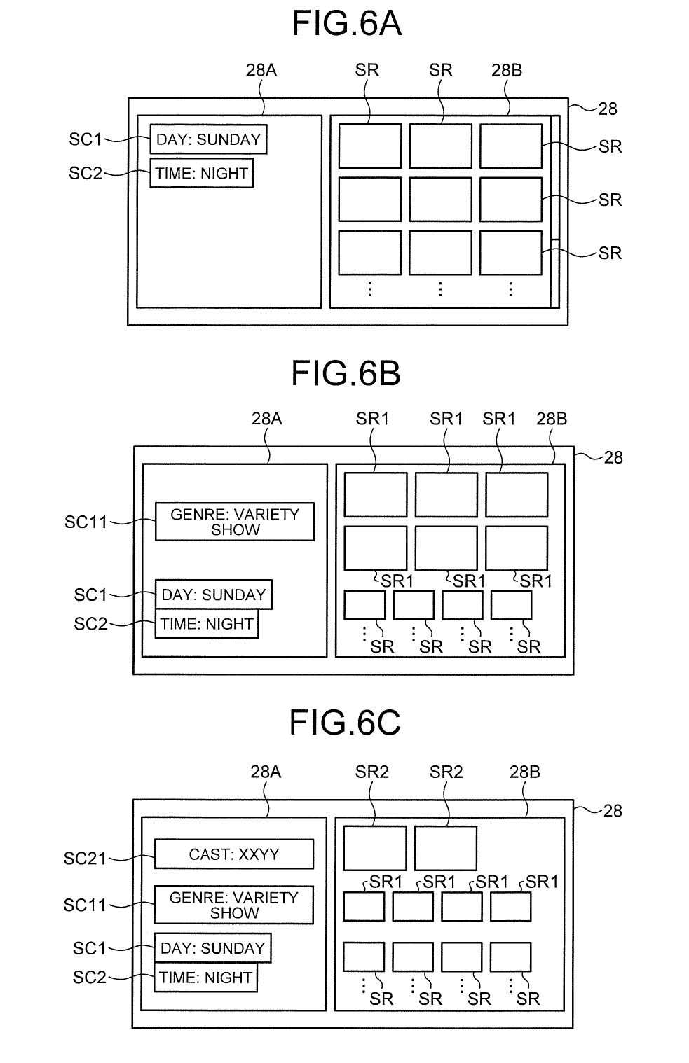

FIGS. 6A to 6C are schematics for explaining a second exemplary approach for displaying the search results on the touch panel display.

As illustrated in FIGS. 6A to 6C, the MPU 21 functioning as the search result display 38 displays pieces of content matching a set of search conditions at the point in time in a more visible manner, and displays nearer search results (search result history) for the previous search results.

FIG. 6A illustrates how the search results are displayed at the point in time at which the search conditions “day: Sunday ( [symbol] )” and “time: night ( [symbol] )” are stored as a set of search conditions in the RAM 23.

As illustrated in FIG. 6A, the screen of the touch panel display 28 is divided into the search condition display area 28A and the search result display area 28B.

In this example, the search condition SC1=“day: Sunday ( [symbol] )” and the search condition SC2=“time: night ( [symbol] )” are displayed in the search condition display area 28A, and it can be seen that a search is performed using these two search conditions SC1 and SC2.

In the search result display area 28B, at least nine search results SR are displayed as results of a search performed using these two search conditions SC1 and SC2.

FIG. 6B illustrates how the search results are displayed at the point in time at which a search condition “genre: variety ( [symbol] )” is stored in the RAM 23, in addition to the search conditions “day: Sunday ( [symbol] )” and “time: night ( [symbol] )”, as a set of search conditions.

As illustrated in FIG. 6B, a newly added search condition SC11=“genre: variety ( [symbol] )” is displayed at the top in the search condition display area 28A in the screen of the touch panel display 28, and the search condition SC1=“day: Sunday ( [symbol] )” and the search condition SC2=“time: night ( [symbol] )”, which are the history of the search conditions, are displayed at the bottom. In this manner, the user can easily recognize that a new refining search condition is the search condition SC11=“genre: variety ( [symbol] )” by simply looking at the search condition display area 28A, and it can be seen that a search is performed using the three search conditions, the search condition SC11 and the search conditions SC1 and SC2.

In the search result display area 28B, six search results SR1 are displayed as results of a search performed using three search conditions SC11, SC1, and SC2. Furthermore, among the search results acquired using the two search conditions SC1 and SC2, which are the first two search conditions, four or more search results SR lower in priority are displayed in a smaller size than search results SR1, so that the user can easily recognize that these are search results that are lower in priority, visually.

FIG. 6C illustrates how the search results are displayed at the point in time at which a search condition “cast: XXYY ( [symbol] )” is stored in the RAM 23, in addition to the search conditions “day: Sunday ( [symbol] )”, “time: night ( [symbol] )”, and “genre: variety ( [symbol] )”, as a set of search condition.

As illustrated in FIG. 6C, a newly added search condition SC21=“cast: XXYY ( [symbol] : ◯◯ΔΔ)” is displayed at the top of the search condition display area 28A in the screen of the touch panel display 28, and the search condition SC11=“genre: variety ( [symbol] )”, the search condition SC1=“day: Sunday ( [symbol] )”, and the search condition SC2=“time: night ( [symbol] )”, which are the history of the search conditions, are displayed at the bottom. In this manner, the user can easily recognize that the new refining search condition is a search condition SC21=“cast: XXYY ( [symbol] : ◯◯ΔΔ)” by simply looking at the search condition display area 28A, and can see that a search is performed using four search conditions of the search condition SC21 and the search conditions SC11, SC1, and SC2.

In the search result display area 28B, two search results SR2 are displayed as results of a search performed using the four search conditions SC21, SC11, SC1, and SC2. In addition, among the search results acquired with the three search conditions SC11, SC1, and SC2 that are refining search conditions previously used, the four search results SR1 and four or more search results SR which are search results lower in priority are displayed in a smaller size than the size of the search results SR2 so that the user can easily recognize that these are search results lower in priority, visually.

As explained above, in the second exemplary approach for displaying the search results on the touch panel display, the search conditions are sequentially added so as to refine the search results, and only the search results thus refined are displayed. Therefore, a user can recognize the search results corresponding to what is spoken by the user quickly, and perform a search smoothly.

Furthermore, when an intended piece of program content is displayed as a search result while the user is still speaking (for example, at the point in time the screen illustrated in FIG. 5B is displayed), the user can make a tapping operation or the like for selecting the search result, and cause the television 11 to replay the content. In this manner, content can be searched simply and quickly.

Furthermore, because unintended, low-priority program content is also displayed in addition to high-priority, latest refined search results, a user can find similar content, and experience the joy of searching, e.g., in discovering some content unexpectedly.

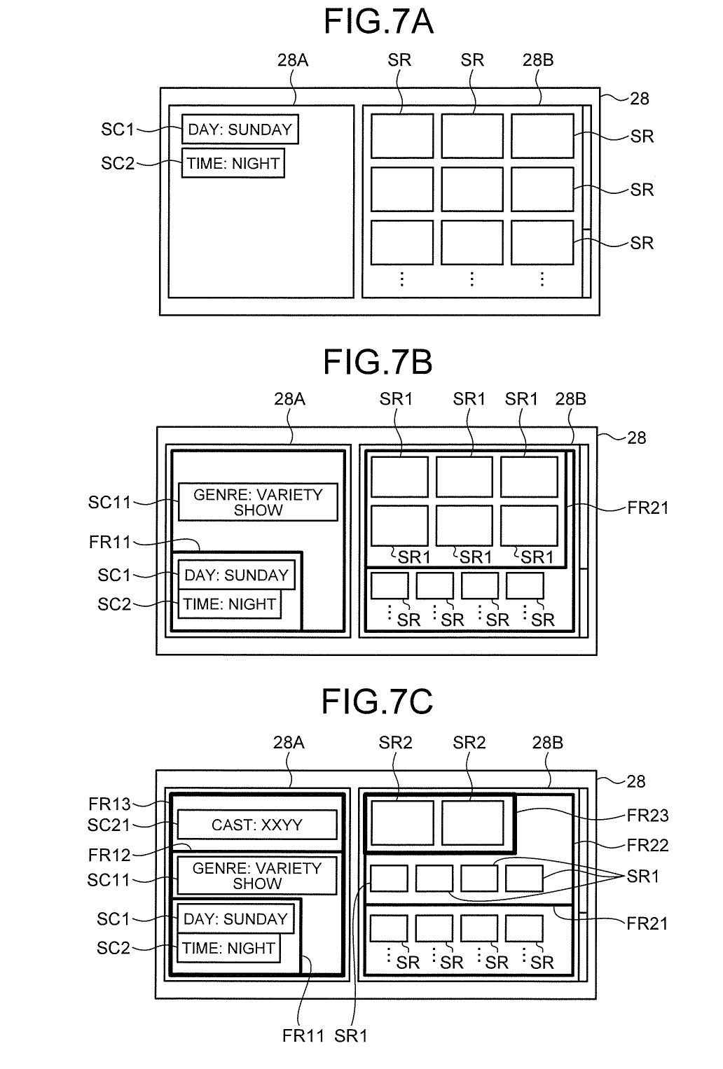

FIGS. 7A to 7C are schematics for explaining a third exemplary approach for displaying the search results on the touch panel display.

As illustrated in FIGS. 7A to 7C, the MPU 21 functioning as the search result display 38 displays a piece of content matching a set of search conditions at that point in time more visibly, and displays nearer search results (search result history) for the previous search results, in the same manner as the second exemplary approach for displaying the search results on the touch panel display 28.

FIG. 7A illustrates how the search results are displayed at the point in time at which the search conditions “day: Sunday ( [symbol] )” and “time: night ( [symbol] )” are stored as a set of search conditions in the RAM 23. Because FIG. 7A is the same as FIG. 6A, a detailed explanation thereof is omitted herein.

FIG. 7B illustrates how the search results are displayed at the point in time at which a search condition “genre: variety ( [symbol] )” is stored in the RAM 23, in addition to the search conditions “day: Sunday ( [symbol] )” and “time: night ( [symbol] )”, as a set of search conditions.

As illustrated in FIG. 7B, a newly added search condition SC11=“genre: variety ( [symbol] )” is displayed at the top of the search condition display area 28A in the screen of the touch panel display 28, and the search condition SC1=“day: Sunday ( [symbol] )” and the search condition SC2=“time: night ( [symbol] )”, which are the history of search conditions, are displayed at the bottom.

In addition, in order to clearly identify the search conditions before the refining search is performed, the search condition SC1=“day: Sunday ( [symbol] )” and the search condition SC2=“time: night ( [symbol] )”, which are the history of the search conditions, are displayed in a manner surrounded by a frame FR11.

In this manner, the user can easily recognize that the new refining search condition is a search condition SC11=“genre: variety ( [symbol] )” by simply looking at the search condition display area 28A, and it can be seen that a search is performed using three search conditions of the search condition SC11 and the search conditions SC1 and SC2.

In the search result display area 28B, six search results SR1 are displayed as results of a search performed using three search conditions SC11, SC1, and SC2. In addition, among the search results acquired using the two search conditions SC1 and SC2 that are first two conditions, four or more search results SR which are search results lower in priority are displayed in a smaller size than the size of the search results SR1. Furthermore, to clearly identify the search results after the refined search, the search results SR1 are displayed in a manner surrounded by a frame FR21.

As a result, the user can easily recognize that the search results SR are lower in priority than the search results SR1, visually.

FIG. 7C illustrates how the search results are displayed at the point in time at which a search condition “cast: XXYY ( [symbol] : ◯◯ΔΔ)” is stored in the RAM 23, in addition to the search conditions “day: Sunday ( [symbol] )”, “time: night ( [symbol] )”, and “genre: variety ( [symbol] )”, as a set of search condition.

As illustrated in FIG. 7C, a newly added search condition SC21=“cast: XXYY ( [symbol] : ◯◯ΔΔ)” is displayed at the top of the search condition display area 28A in the screen of the touch panel display 28, and the search condition SC11=“genre: variety ( [symbol] )”, the search condition SC1=“day: Sunday ( [symbol] )” and the search condition SC2=“time: night ( [symbol] )”, which are the history of search conditions, are displayed at the bottom.

In addition, in order to clearly identify the search conditions before the refined search, the search condition SC1=“day: Sunday ( [symbol] )” and the search condition SC2=“time: night ( [symbol] )”, which are the history of the search conditions, are displayed in a manner surrounded by the frame FR11. The search condition SC11=“genre: variety ( [symbol] )” is displayed in a manner surrounded by a frame FR12, and the search condition SC21=“cast XXZZ ( [symbol] : ◯◯ΔΔ)” is displayed in a manner surrounded by a frame FR13.

In this manner, the user can easily recognize that the new refining search condition is the search condition SC21=“cast: XXYY ( [symbol] : ◯◯ΔΔ)” by simply looking at the search condition display area 28A, and it can be seen that a search is performed using four search conditions of the search condition SC21 and the search conditions SC11, SC1, and SC2.

In the search result display area 28B, two search results SR2 are displayed as results of a search performed using the four search conditions SC21, SC11, SC1, and SC2. In addition, among the search results acquired using the three search conditions SC11, SC1, and SC2 which are the refined search conditions used previously, four search results SR1 and four or more search results SR lower in priority are all displayed in a smaller size than the size of the search results SR2. Furthermore, in order to clearly identify the search results after the refined search, the search results SR2 are displayed in a manner surrounded by a frame FR22. The search results SR1 are displayed in a manner surrounded by a frame FR21, and the search results SR2 are displayed in a manner surrounded by the frame FR23. Each of the frames may be displayed in a different color correspondingly to the search conditions, or search conditions and the search results corresponding to the search conditions may be displayed in a manner surrounded by frames in the same color.

As a result, the user can easily recognize that the other search results SR1 and SR are search results that are lower in priority than the search results SR2, visually.

As explained above, the third exemplary approach for displaying the search results on the touch panel display enables a user to recognize the search results higher in priority and search conditions corresponding to the search results more clearly, advantageously, as well as achieving the advantageous effects achieved in the second exemplary approach for displaying the search results on the touch panel display.

The three exemplary approaches for displaying the search results explained above assume that the search is simply refined. However, there are also cases in which a search condition itself is modified, because a search condition is modified as a user speaks, or the user corrects the search condition later in time, for example.

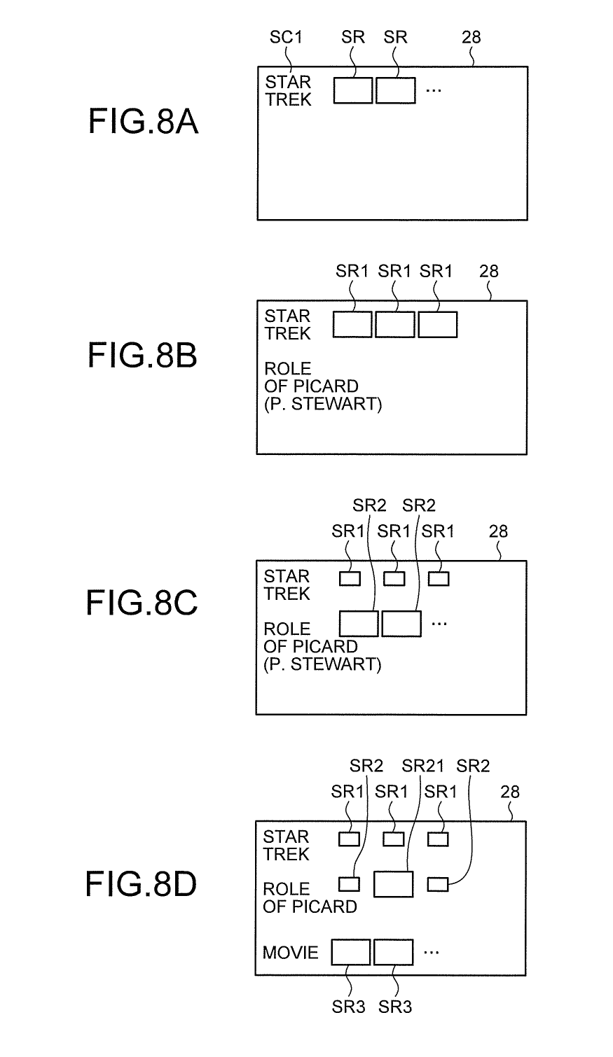

FIGS. 8A to 8D are schematics for explaining a fourth exemplary approach for displaying the search results on the touch panel display.

Explained in FIGS. 8A to 8D is an example in which a search condition is switched as a user speaks.

Explained below is an example in which the voice entered by a user is “the movie in which the man playing Picard in Star Trek is cast ( [symbol] [symbol] [symbol] )”.

The DSP 25 functioning as the sequential voice recognizing module 32 sequentially performs the voice recognition process from the head of the entered voice, and outputs partial voice recognition results of “the movie ( [symbol] )”, “the man playing Picard ( [symbol] )”, “in Star Trek ( [symbol] )”, and “is cast ( [symbol] )”, sequentially, as the voice is entered.

In response, the MPU 21 functioning as the search condition generator 34 refers to the search condition dictionary 33 stored in the ROM 22 or the flash ROM 24, analyzes the text data that is the input partial voice recognition results, and generates search conditions, sequentially.

At the point in time at which the user speaks “in Star Trek ( [symbol] )”, in the beginning, the MPU 21 in the tablet 14 in the embodiment determines that “it is assumed that the user wants to make a search about Star Trek”, and performs a search using “title: Star Trek”.

As a result, as illustrated in FIG. 8A, the screen of the touch panel display 28 displays the search condition SC1 “Star Trek ( [symbol] )”, and a plurality of search results SR.

At the point in time at which the user speaks up to “the man playing Picard ( [symbol] )”, the MPU 21 in the tablet 14 determines that the user wants to make a search about “an actor who played the role of Picard in Star Trek ( [symbol] [symbol] [symbol] )”, and performs the searching process.

As a result, the MPU 21 acquires a search result indicating that “P. Stewart” plays the role of Picard, and a new search condition SC2 being “the role of Picard (P. Stewart) ( [symbol] (P. [symbol] ))” and a plurality of (three, in FIG. 8B) search results SR1 are displayed on the screen of the touch panel display 28, as illustrated in FIG. 8B. At this point in time, because a plurality of search results SR1 have the same priority, the search results SR1 are displayed in the same size on the screen of the touch panel display 28.

When the user speaks up to the phrase “is cast ( [symbol] )”, the MPU 21 determines that the user wants to search content matching “cast: P. Stewart”, instead of that matching “title: Star Trek”.

Therefore, the MPU 21 functioning as the searching module 36 ends the first search for “Star Trek ( [symbol] )” at this point in time, and performs a search using a search condition “P. Stewart (P. [symbol] )”, and displays a search result on the screen of the touch panel display 28, as illustrated in FIG. 8C.

In other words, in the screen of the touch panel display 28, in order to indicate that the search results SR2 resulting from the search condition “the role of Picard (P. Stewart) ( [symbol] (P. [symbol] ))” is higher in priority, the search results SR2 are displayed larger than the search results SR1 acquired resulting from the search condition “Star Trek ( [symbol] )” (the search results SR are displayed in a relatively smaller size).

In the example illustrated in FIG. 8C, the search results SR1 corresponding to the search condition “Star Trek ( [symbol] )” are displayed on the same screen. However, the search results SR1 may be deleted or may be displayed less visibly.

At the point in time at which the user speaks up to the phrase “the movie ( [symbol] )”, because “the movie ( [symbol] )” corresponds to a refining search, the MPU 21 functioning as the searching module 36 refines the search to the movie ( [symbol] ) content including “P. Stewart ( [symbol] )”, and makes a display illustrated in FIG. 8C.

In other words, in the screen of the touch panel display 28, in order to indicate that a search result SR21 satisfying the search condition “movie ( [symbol] )” is higher in priority among the search results SR3 corresponding to the search condition=“the role of Picard (P. Stewart) ( [symbol] (P. [symbol] ))”&a “movie ( [symbol] )” and the search results SR2 corresponding to the search condition=“the role of Picard (P. Stewart) ( [symbol] (P. [symbol] ))”, the search result SR21 is displayed in a larger size than the size of the search results SR2 not satisfying the search condition “movie ( [symbol] )”, among the search results SR1 resulting from the search condition “Star Trek ( [symbol] )” and the search results SR2 resulting from the search condition=“the role of Picard (P. Stewart) ( [symbol] (P. [symbol] ))” (the search results SR and the search results SR2 are displayed in a relatively smaller size).

As explained above, even in a case in which a search condition is switched as a user speaks, the search condition can be switched sequentially based on the content of the entered voice, and a search can be performed based on the entered voice that is the same as that targeted for a human.

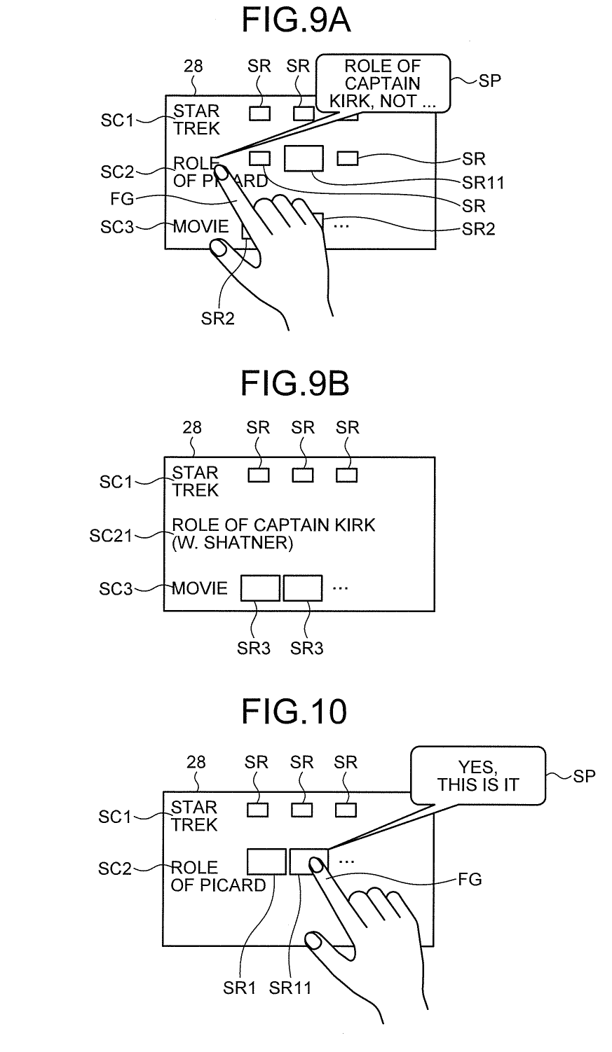

FIGS. 9A and 9B are schematics for explaining a fifth exemplary approach for displaying the search results on the touch panel display.

Explained in FIGS. 8A to 8D is an example in which switching of a search condition is automatically detected when the search condition is switched as a user speaks. Explained in FIGS. 9A and 9B is an example in which the user intentionally modifies a part of a search condition.

As a first way, it is possible for a user to speak “the role of Captain Kirk, not the role of Picard ( [symbol] [symbol] )”, solely by voice. In such a case, because, in the voice entered up to this point in time, only “the role of Captain Kirk ( [symbol] )”, which is a role name, is replaced with “the role of Picard ( [symbol] )”, the MPU 21 searches for movies casting “W. Shatner (W. [symbol] )”, which are the result acquired by searching with the actor playing “the role of Captain Kirk ( [symbol] )”, instead of movies casting “P. Stewart (P. [symbol] )”, and displays the results.

As a second way, it is possible for the user to indicate which search condition is to be replaced by taking advantage of a touching operation performed on the touch panel display 28.

FIG. 9A is a schematic for explaining an operation performed by a user by pointing to a search condition to be replaced when the user finds out that the user wants to make a search for an actor who played the role of “Captain Kirk ( [symbol] )”, instead of the actor who played the role of “Picard ( [symbol] )”, after the user entered voice in the same manner as illustrated in FIGS. 8A to 8D.

In FIG. 9A, the user touches to identify the search condition to be replaced using a finger FG.

In this condition, the user can replace the search condition SC2=“the role of Picard ( [symbol] )” with the search condition SC21=“the role of Captain Kirk (W. Shatner) ( [symbol] (W. [symbol] ))” by entering voice SP=“Captain Kirk ( [symbol] )”, as illustrated in FIG. 9B.

Asa result, the search results are also changed from the search results SR2 resulting from the search condition SC2=“the role of Picard ( [symbol] )” to search results SR3 resulting from the search condition SC21=“the role of Captain Kirk (W. Shatner) ( [symbol] (W. [symbol] ))”. The search results SR resulting from the search condition SC1=“Star Trek ( [symbol] )” could also be changed.

Explained above is an example in which the search condition to be replaced is identified using the finger FG. However, the search condition may also be replaced by speaking “Captain Kirk ( [symbol] )”, while the user is pointing to “Picard ( [symbol] )” displayed on the screen, using any device that can identify a user instruction, e.g., a mouse, a pen, or a camera.

FIG. 10 is a schematic for explaining an example transiting operation for transiting to a replaying operation in the middle of a search.

Displayed in the same screen in the example in FIG. 10 are the search results SR1 and SR11 resulting when the search condition SC1=“Star Trek ( [symbol] )” and the search condition SC2=“the role of Picard ( [symbol] )” are specified, and the search results SR resulting when the search condition SC1=“Star Trek ( [symbol] )” are specified.

In this condition, if the search result SR11 is the desired piece of program content, the user identifies the program content by touching the search result SR11 with the finger FG, as illustrated in FIG. 10.

In this condition, the user can enter voice indicating to end the search, such as voice SP=“Yes, this is it”, to cause the piece of program content corresponding to the search result SR11 to be replayed on the television 11. In this manner, the replaying operation can be simplified and accelerated.

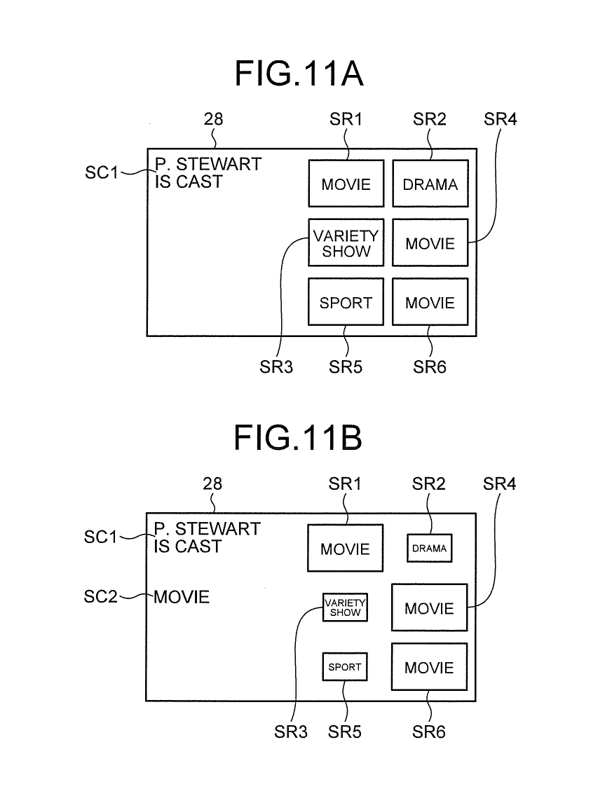

FIGS. 11A and 11B are schematics for explaining a first approach for updating displayed content.

In the example illustrated in FIG. 11A, the screen of the touch panel display 28 displays search results SR1 to SR6 acquired when the search condition SC1=“P. Stewart is cast (P. [symbol] [symbol] )” (program) is specified.

In this condition, when the second search condition SC2=“movie ( [symbol] )” is specified, only the search results SR1, SR4, and SR6 matching the second search condition SC2=“movie ( [symbol] )” are displayed in the original size, and the other search results SR2, SR3, and SR5 are displayed in a relatively smaller size, as illustrated in FIG. 11B, so that the priority of the other search results SR2, SR3, and SR5 being lower is clearly indicated.

As a result, the user can recognize desired search results more easily.

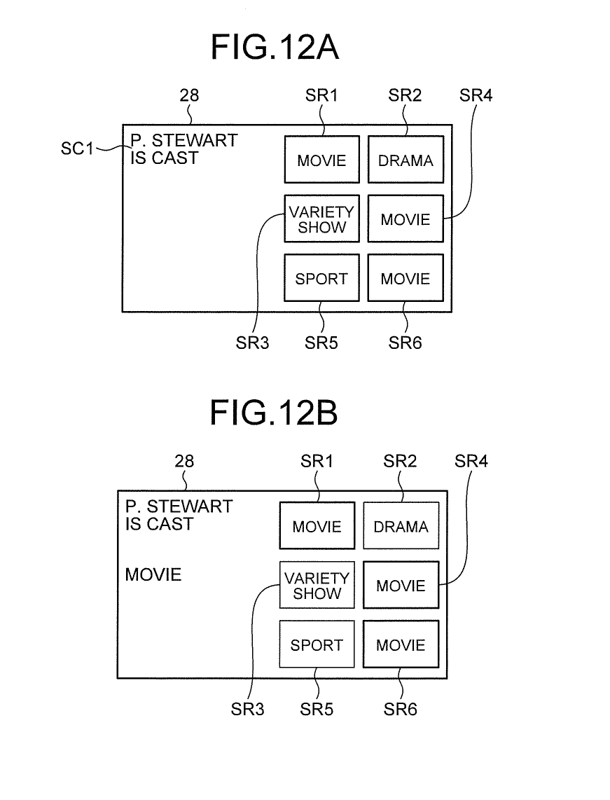

FIGS. 12A and 12B are schematics for explaining a second approach for updating displayed content.

In the example illustrated in FIG. 12A, the screen of the touch panel display 28 displays search results SR1 to SR6 acquired when the search condition SC1=“P. Stewart is cast (P. [symbol] [symbol] )” (program) is specified.

In this condition, when the second search condition SC2=“movie ( [symbol] )” is specified, only the search results SR1, SR4, and SR6 matching the second search condition SC2=“movie ( [symbol] )” are displayed in the original size, and the other search results SR2, SR3, and SR5 are displayed in a relatively lighter color, as illustrated in FIG. 12B, so that the priority of the other search results SR2, SR3, and SR5 being lower is clearly indicated.

As a result, the user can recognize desired search results more easily.

Similarly, the search results SR1, SR4, and SR6 may be displayed in an emphasized manner.

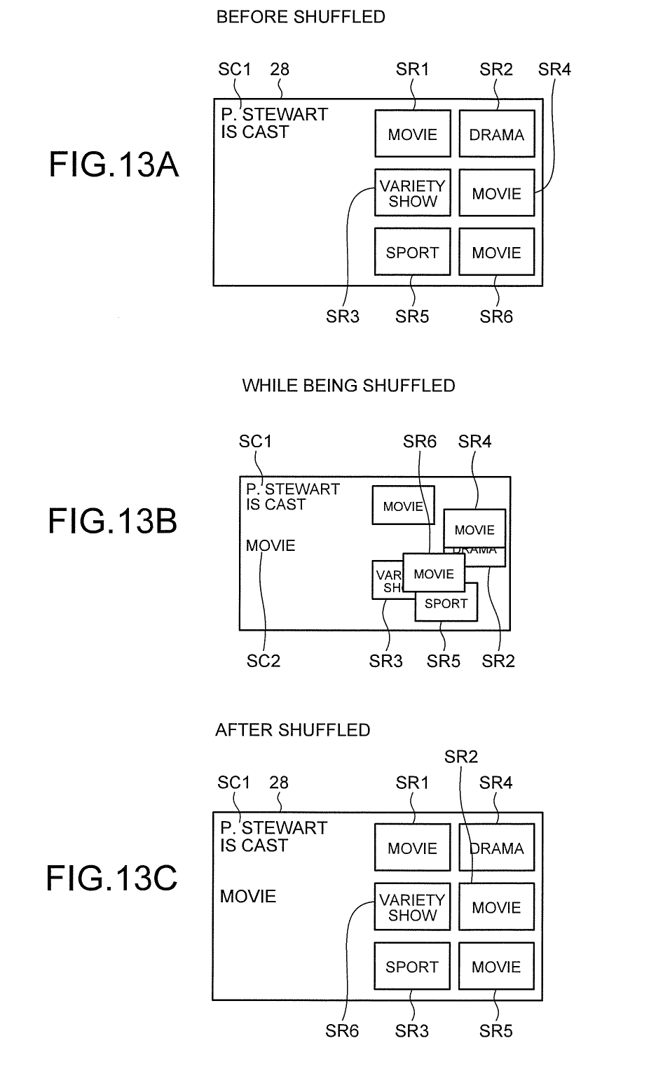

FIGS. 13A to 13C are schematics for explaining a third approach for updating displayed content.

In this approach for updating displayed content, the search results are displayed as an animation, and the positions of the search results are moved between before and after the refined search, based on the priorities.

In the example illustrated in FIG. 13A, the screen of the touch panel display 28 displays search results SR1 to SR6 acquired when the search condition SC1=“P. Stewart is cast (P. [symbol] [symbol] )” (program) is specified.

In this condition, when the second search condition SC2=“movie ( [symbol] )” is specified, the size of the search results SR1 to SR6 is once reduced, and the search results SR1 to SR6 are shuffled through the screen of the touch panel display 28, as illustrated in FIG. 13B.

The search results SR1 to SR6 are then finished being shuffled at positions at which search results higher in priority are positioned more on the left side than the right side, and more on the upper side than on the lower side.

In other words, the search results SR1, SR4, and SR6 matching the second search condition SC2=“movie ( [symbol] )” are gathered on the upper left side, and other search results SR2, SR3, and SR5 are gathered relatively on the lower right side, and these search results are eventually displayed at the original size.

As a result, a user can easily recognize that the search results positioned at a given position (e.g., more on the upper left side in the example illustrated in FIG. 13) are the search results that the user desired.

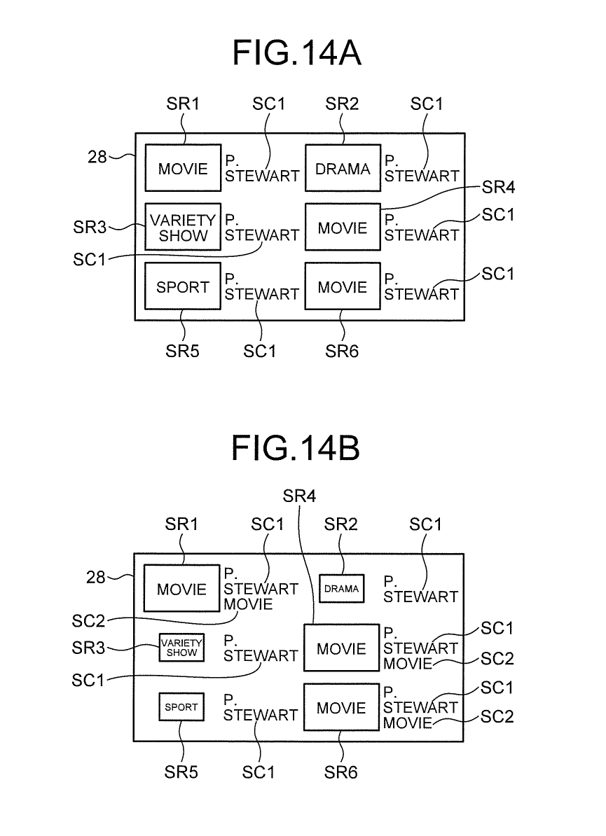

FIGS. 14A and 14B are schematics for explaining a fourth approach for updating displayed content.

In this approach for updating displayed content, corresponding search conditions are displayed with the search results, and the search results with less matching search conditions are displayed in a smaller size.

In the example illustrated in FIG. 14A, the screen of the touch panel display 28 displays search results SR1 to SR6 acquired when the search condition SC1=“P. Stewart (P. [symbol] )” (program) is specified.

In such a case, because all of the search results SR1 to SR6 satisfy the search condition SC1, these search results SR1 to SR6 are displayed in the same size, and the search condition SC1 is displayed near each of these search results SR1 to SR6.

In this condition, if the second search condition SC2=“movie ( [symbol] )” is specified, the search results SR1, SR4, and SR6 satisfying the search condition SC1=“P. Stewart (P. [symbol] )” and the search condition SC2=“movie ( [symbol] )” are displayed in the original size, and the search condition SC1 and the search condition SC2 are displayed near each of these search results SR1, SR4, and SR6, as illustrated in FIG. 14B.

By contrast, the search results SR2, SR3, and SR5 not satisfying the search condition SC2=“movie ( [symbol] )” are displayed in a smaller size to indicate that these search results are lower in priority. Only the search condition SC1 is displayed near each of the search results SR2, SR3, and SR5.

As a result, the user can easily recognize that the search result displayed in a larger size and near which more search conditions are displayed are the search results that the user desired.

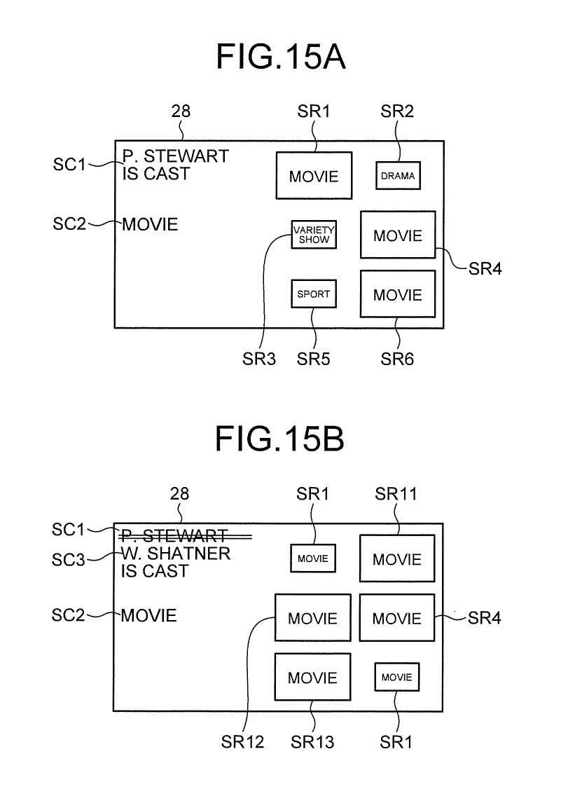

FIGS. 15A and 15B are schematics for explaining a fifth approach for updating displayed content.

In the example illustrated in FIG. 15A, the screen of the touch panel display 28 displays search results SR1 to SR6 acquired when the search condition SC1=“P. Stewart is cast (P. [symbol] [symbol] )” and the search condition SC2=“movie ( [symbol] )” are specified.

In other words, the search results SR1, SR4, and SR6 satisfying both of the first search condition SC1=“P. Stewart is cast (P. [symbol] [symbol] )” and the second search condition SC2=“movie ( [symbol] )” are displayed in the original size, and the other search results SR2, SR3, and SR5 are displayed in a relatively smaller size, to indicate that these search results SR2, SR3, and SR5 are lower in priority.

In this condition, if a third search condition SC3=“W. Shatner is cast (W. [symbol] [symbol] )” is specified in replacement of the first search condition SC1=“P. Stewart is cast (P. [symbol] [symbol] )”, the search results not satisfying the third search condition SC3=“W. Shatner is cast (W. [symbol] [symbol] )”, among the other search results SR2, SR3, and SR5 already displayed in a smaller size before the third search condition SC3 is specified, are replaced with new search results SR11 to SR13.

Among the search results not displayed in a smaller size before the third search condition is specified, that is, among the search results SR1, SR4, and SR6 satisfying the first search condition SC1=“P. Stewart is cast (P. [symbol] [symbol] )” and the second search condition SC2=“movie ( [symbol] )”, the search results SR1 and SR6 not satisfying the third search condition SC3=“W. Shatner is cast (W. [symbol] [symbol] )” are displayed in a relatively smaller size, to indicate that these search results SR1 and SR6 are lower in priority.

As a result, the user can easily recognize desired search results satisfying all search conditions.

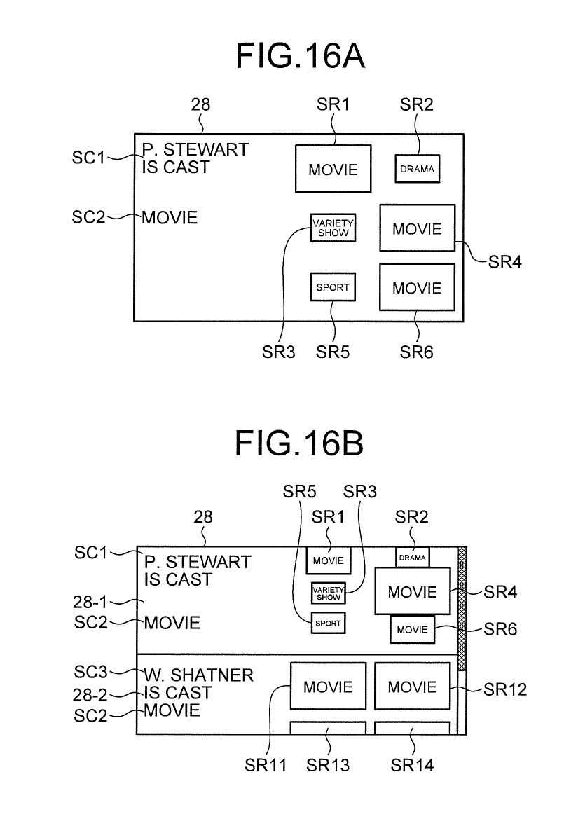

FIGS. 16A and 16B are schematics for explaining a sixth approach for updating displayed content.

In the example illustrated in FIG. 16A, the screen of the touch panel display 28 displays search results SR1 to SR6 acquired when the search condition SC1=“P. Stewart is cast (P. [symbol] [symbol] )” and the search condition SC2=“movie ( [symbol] )” are specified.

In other words, the search results SR1, SR4, and SR6 satisfying the first search condition SC1=“P. Stewart is cast (P. [symbol] [symbol] )” and the second search condition SC2=“movie ( [symbol] )” are displayed in the original size, and the other search results SR2, SR3, and SR5 are displayed in a relatively smaller size, to indicate that these search results SR2, SR3, and SR5 are lower in priority.

In this condition, if the first search condition SC1=“P. Stewart is cast (P. [symbol] [symbol] )” is replaced with the third search condition SC3=“W. Shatner is cast (W. [symbol] [symbol] )”, the screen of the touch panel display 28 is divided into two sections, and the original search results SR1 to SR6 are displayed in a first display area 28-1 and the search results SR1 to SR3, SR5, and SR6 other than the search result SR4 satisfying the third search condition SC3=“W. Shatner is cast (W. [symbol] [symbol] )” are displayed in a relatively smaller size, indicating that these search results SR1 to SR3, SR5, and SR6 are lower in priority.

By contrast, new search results SR11 to SR14 satisfying all of the first search condition SC1=“P. Stewart is cast (P. [symbol] [symbol] )”, the second search condition SC2=“movie ( [symbol] )”, and the third search condition SC3=“W. Shatner is cast (W. [symbol] [symbol] )” are displayed in a second display area 28-2 in a standard size.

As a result, the user can easily recognize that the search results displayed in a larger size are the search results that the user desired.

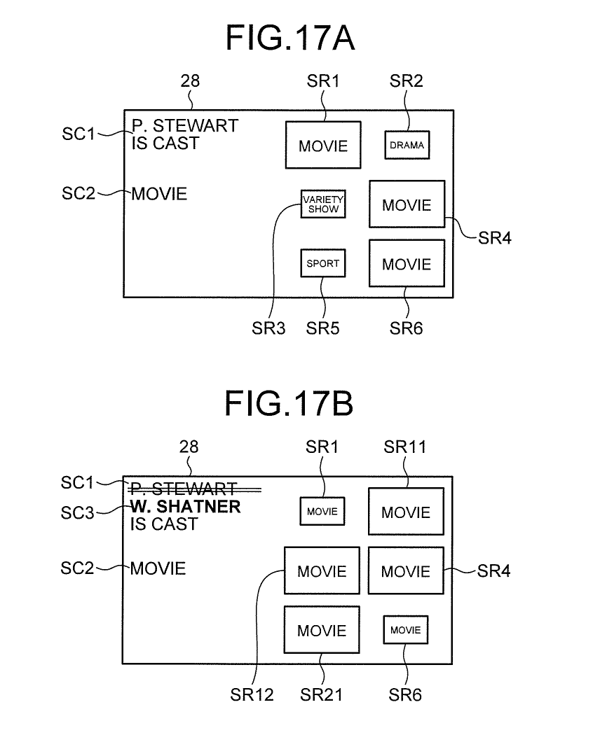

FIGS. 17A and 17B are schematics for explaining a seventh approach for updating displayed content.

In the seventh approach for updating the displayed content, when a search condition having already been entered is modified to a new search condition, the new search condition after the modification is considered more important, and handled as a search condition with a higher priority than a search condition that is modified.

In the example illustrated in FIG. 17A, the screen of the touch panel display 28 displays the search results SR1 to SR6 acquired when the search condition SC1=“P. Stewart is cast (P. [symbol] [symbol] )” and the search condition SC2=“movie ( [symbol] )” are specified.

In other words, the search results SR1, SR4, and SR6 satisfying the first search condition SC1=“P. Stewart is cast (P. [symbol] [symbol] )” and the second search condition SC2=“movie ( [symbol] )” are displayed in the original size (standard size), and the other search results SR2, SR3, and SR5 are displayed in a relatively smaller size, to indicate that these search results SR2, SR3, and SR5 are lower in priority.

In this condition, if the first search condition SC1=“P. Stewart is cast (P. [symbol] [symbol] )” is replaced with the third search condition SC3=“W. Shatner is cast (W. [symbol] [symbol] )”, the third search condition SC3=“W. Shatner is cast (W. [symbol] [symbol] )” having been newly entered is considered more important than the second search condition SC2=“movie ( [symbol] )” not having been modified, and the third search condition SC3=“W. Shatner is cast (W. [symbol] [symbol] )” is displayed in an emphasized manner on the screen of the touch panel display 28.

In replacement of the search results SR2, SR3, and SR5 not satisfying the second search condition SC2=“movie ( [symbol] )” and the third search condition SC3=“W. Shatner is cast (W. [symbol] [symbol] )”, new search results SR11 and SR12 satisfying the second search condition SC2=“movie ( [symbol] )” and the third search condition SC3=“W. Shatner is cast (W. [symbol] [symbol] )” are displayed in the standard size.

When the number of search results is small, the third search condition SC3=“W. Shatner is cast (W. [symbol] [symbol] )” is considered more important than the second search condition SC2=“movie ( [symbol] )” not having been modified, and search results SR21 satisfying the third search condition SC3=“W. Shatner is cast (W. [symbol] [symbol] )” but not satisfying the second search condition SC2=“movie ( [symbol] )”, that is a search result of a “drama” in which W. Shatner is cast (W. [symbol] [symbol] ) is displayed.

As a result, the user can easily recognize that the search result satisfying the search condition displayed in an emphasized manner and displayed in a larger size are the search results that the user desired.

In the explanations above, it is assumed that the DSP 25 functioning as the sequential voice recognizing module 32 sequentially performs the voice recognition process from the head of the entered voice, and correctly outputs partial voice recognition results “in Star Trek ( [symbol] [symbol] )”, “the man playing Picard ( [symbol] )”, “is cast ( [symbol] )”, and “movie ( [symbol] )” sequentially, as the voice is entered. However, depending on the voice recognition technologies, phrases might be output incorrectly in the middle of the speech, and corrected later on. For example, up to the point at which only “Star Trek ( [symbol] )” is spoken, no linkage to a previous phrase or to a following phrase can be assumed. Therefore, an incorrect voice recognition result might be acquired, and the voice might be recognized as “Without Trace ( [symbol] [symbol] )”. In such a case, in the embodiment, the “title: Without Trace ( [symbol] [symbol] )” is first recognized and searched. When the voice is entered up to “Picard ( [symbol] )”, the recognition result of the first phrase is corrected to “Star Trek ( [symbol] [symbol] )” based on the linkage between the previous phrase and the following phrase. In such a case, “title: Without Trace ( [symbol] [symbol] )” is corrected to “title: Star Trek ( [symbol] )”, and searched content is updated in the manner described above.

Explained above is an example in which a tablet functions as a content searching apparatus. However, a server connected to an information processing apparatus such as a tablet over a communication network such as the Internet may be configured to realize the functions of the content searching apparatus.

Alternatively, the functions of the content searching apparatus may be realized in a manner distributed to each of a plurality of servers deployed on a communication network.

The control program executed by the content searching apparatus according to the embodiment is provided in a manner recorded in a computer-readable recording medium such as a compact disk read-only memory (CD-ROM), a flexible disk (FD), a compact disk recordable (CD-R), or a digital versatile disk (DVD), as a file in an installable or executable format.

Furthermore, the control program executed by the content searching apparatus according to the embodiment may be provided in a manner stored in a computer connected to a network such as the Internet, and made available for download over the network. Furthermore, the control program executed by the content searching apparatus according to the embodiment may be provided or distributed over a network such as the Internet.

Furthermore, the control program executed by the content searching apparatus according to the embodiment may be provided in a manner incorporated in a ROM or the like in advance.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content searching apparatus comprising:
a search condition generator configured to perform voice recognition in parallel with an input of a natural language voice giving an instruction for a search for a piece of content, and to generate search conditions sequentially;
a searching module configured to perform a content search while updating the search condition used in the search as the search condition is generated; and
a search result display configured to update the search condition used in the content search and a result of the content search based on the search condition to be displayed as the search condition is generated.

2. The content searching apparatus of claim 1, wherein the search condition generator comprises:
a voice recognizing module configured to perform voice recognition of the natural language voice to output text data; and
an analyzer and generator configured to analyze the text data to generate the search condition.

3. The content searching apparatus of claim 1, wherein the search condition generator is configured to, when a new search condition to be replaced with the search condition used in the content search is generated, replace a part of the search conditions used in the content search with the new search condition.

4. The content searching apparatus of claim 1, further comprising:
a search condition designator configured to designate one of the displayed search conditions used in the content search; and
a search condition replacing module configured to replace the designated search condition with a newly generated search condition.

5. The content searching apparatus of claim 1, wherein a screen of the search result display comprises:
a search condition display area configured to display the search conditions used in the content search; and
a content search result display area configured to display a result of the content search in association with the search conditions used in the content search.

6. The content searching apparatus of claim 1, wherein the search result display is configured to display a history of the search conditions used in the content search.

7. The content searching apparatus of claim 1, wherein the search result display is configured to display results of the content search in different manners based on whether all of the search conditions are satisfied.

8. The content searching apparatus of claim 7, wherein the manners are changed by changing sizes to be displayed, emphasizing or not emphasizing the results, or displaying the results in a lighter color or not displaying in the lighter color.

9. The content searching apparatus of claim 1, further comprising:
a selecting operation module configured to perform an operation of selecting one of the content search results displayed on the search result display, wherein
the searching module is configured to end a content searching process when the selecting operation module selects one of the content search results.

10. The content searching apparatus of claim 9, wherein the selecting operation module and the search result display are configured as a touch panel display, the content searching apparatus further comprising:
a replay instructing module configured to output a replay instruction signal of content corresponding to the selected content search result to an apparatus to be controlled when an operation of selecting the one of the content search results is performed on a screen of the touch panel display.

11. A content searching method executed on a content searching apparatus that performs a content search, the content searching method comprising:
performing voice recognition in parallel with an input of a natural language voice giving an instruction for a search for a piece of content, and generating search conditions sequentially;
performing a content search while updating the search condition used in the search as the search condition is generated; and
updating the search condition used in the content search and a result of the content search based on the search condition and to be displayed as the search condition is generated.

12. A computer program product having a non-transitory computer readable medium including programmed instructions, wherein the instructions, when executed by a computer, cause the computer to perform:
performing voice recognition in parallel with an input of a natural language voice giving an instruction for a search for a piece of content, and to generating search conditions sequentially;
performing a content search while updating the search condition used in the search as the search condition is generated; and
updating the search condition used in the content search and a result of the content search based on the search condition and to be displayed as the search condition is generated.
